(19) United States
(12) Patent Application Publication
(10) Pub. No.: US 2011/0273038 A1
(43) Pub. Date: Nov. 10, 2011

(54) MOTOR RING AND SPLASH SHIELD ARRANGEMENT FOR A FAN ASSEMBLY

(75) Inventors: Robert Naman, Natick, MA (US); Bhaskar Ray, Tyngsborough, MA (US)

(73) Assignee: ROBERT BOSCH GMBH, Stuttgart (DE)

(21) Appl. No.: 12/775,659

(22) Filed: May 7, 2010

(51) Int. Cl. H02K 9/02; H02K 5/10

(52) U.S. Cl. 310/58; 310/88

(57) ABSTRACT

A fan assembly includes a motor ring and an electric motor supported by the motor ring and including an output shaft defining a central axis, a brush assembly, and a motor end shield having at least one aperture and disposed adjacent the brush assembly. The fan assembly further includes a splash shield adjacent the motor end shield. The splash shield includes a rim having an inner surface in facing relationship with the motor end shield and configured to direct an airflow between the motor end shield and the splash shield in a substantially radial direction toward the central axis, and configured to redirect the substantially radial airflow through the aperture in a direction having both a radial and an axial component with respect to the central axis.

### BACKGROUND

The present invention relates to engine-cooling fans, and more particularly to the motor ring and splash shield arrangements used with engine-cooling fans.

Engine-cooling fan systems consist in part of a shroud, a fan, and a motor. The motor is supported by a motor ring of the shroud and is often cooled by airflow passing axially through the motor. The cooling airflow is typically generated by ribs on the fan hub. Splash shields have been used to reduce the amount of undesirable solid particles or liquid that enters the motor with the cooling airflow. However, splash shields can often reduce the amount of cooling airflow through the motor, which can cause an increase in motor temperature, potentially reducing the life expectancy of the motor.

### SUMMARY

In one embodiment, the invention provides a fan assembly including a motor ring and an electric motor supported by the motor ring. The electric motor includes an output shaft defining a central axis, a brush assembly, and a motor end shield having at least one aperture and disposed adjacent the brush assembly. The fan assembly further includes a splash shield adjacent the motor end shield. The splash shield includes a rim having an inner surface in facing relationship with the motor end shield and configured to direct an airflow between the motor end shield and the splash shield in a substantially radial direction toward the central axis, and configured to redirect the substantially radial airflow through the aperture in a direction having both a radial and an axial component with respect to the central axis.

Other aspects of the invention will become apparent by consideration of the detailed description and accompanying drawings.

### BRIEF DESCRIPTION OF THE DRAWINGS

FIG. 1 is a rear perspective view of a first embodiment of a fan assembly embodying the invention.

FIG. 2 is a front exploded view of the fan assembly of FIG. 1.

FIG. 3 is a rear exploded view of the fan assembly of FIG. 1, illustrating a splash shield, a motor ring, and a motor end shield.

FIG. 4 is a section view of the assembled splash shield, motor ring, and motor end shield taken along line 4-4 of FIG. 1.

FIG. 5 is an enlarged view of the splash shield, motor ring, and motor end shield shown in FIG. 4.

FIG. 6 is a section view of a splash shield, motor ring, and motor end shield of a second embodiment of a fan assembly embodying the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

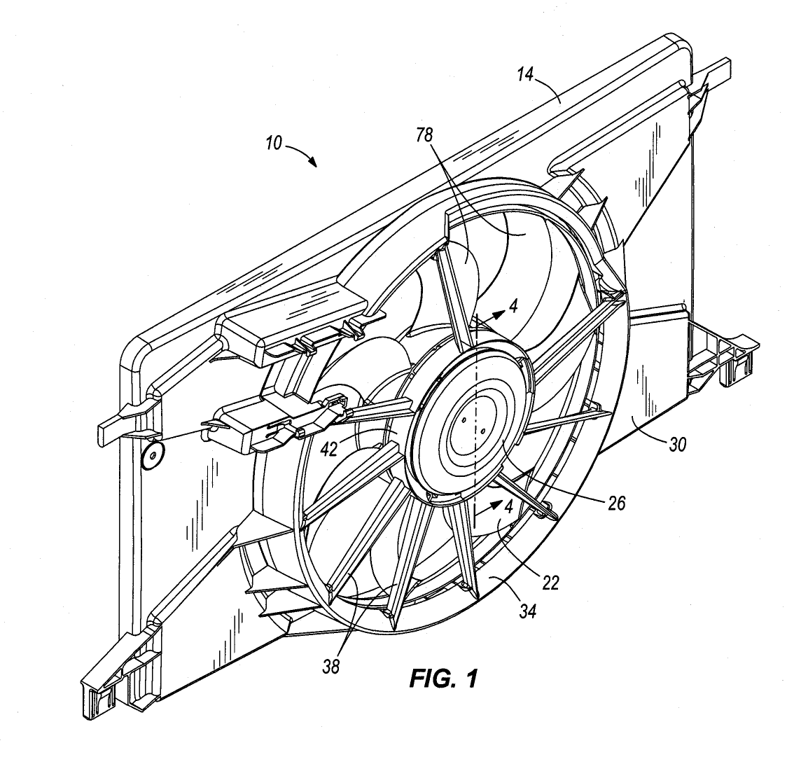

FIGS. 1-3 illustrate a fan assembly 10 of the present invention. The illustrated fan assembly 10 is an engine-cooling fan assembly of the type used in vehicles for cooling the internal combustion engine. However, the present invention can be practiced with other types of fan assemblies as well. The fan assembly 10 includes a shroud 14 that supports the remainder of the fan assembly 10 proximate a radiator in a vehicle, an electric motor 18 supported by the shroud 14, a fan 22 drivably coupled to the motor 18 for rotation relative to the shroud 14 about a central axis 24, and a splash shield 26 positioned adjacent an end of the motor 18 to substantially prevent solid particles (e.g., debris) or liquid (e.g., water) from entering the motor 18 with a cooling airflow that flows into and through the motor 18.

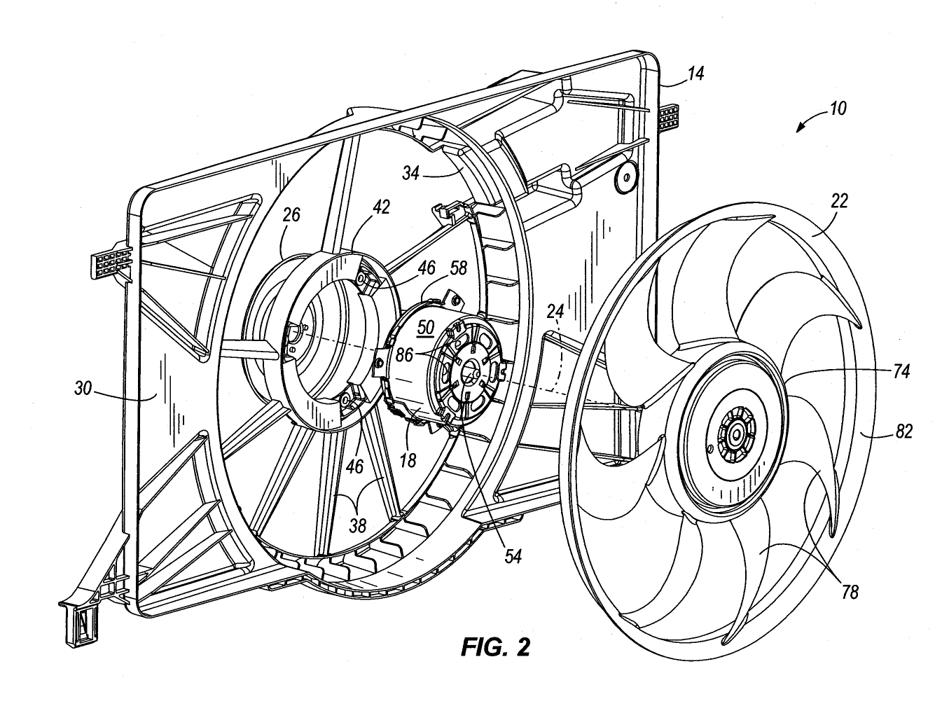

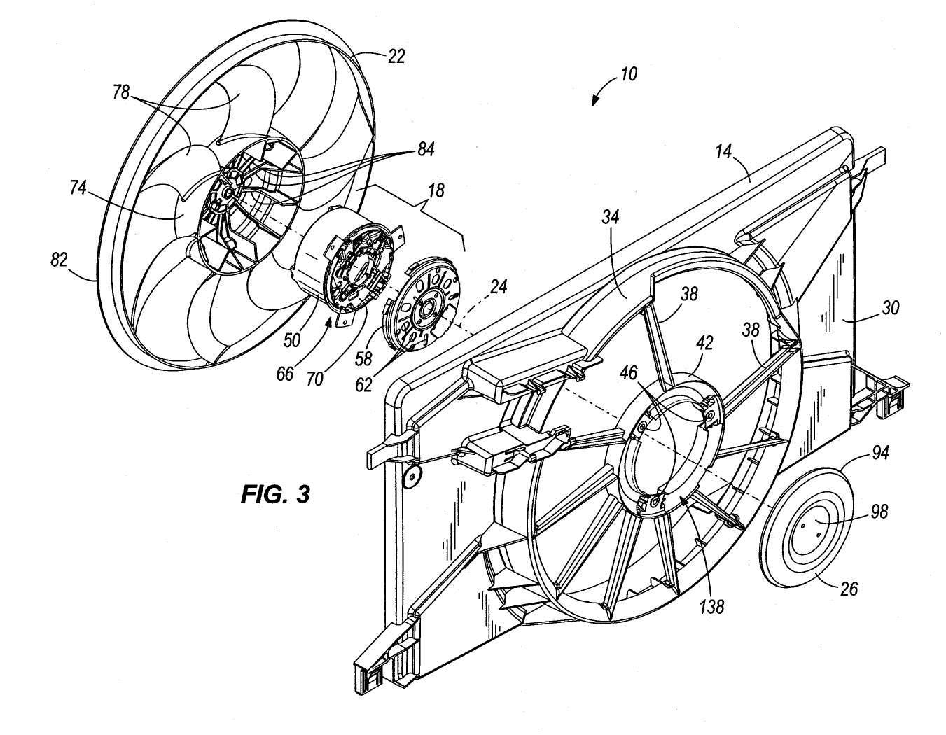

The illustrated shroud 14 is an integrally-molded plastic part having a plenum portion 30, a fan barrel portion 34 for receiving the fan 22, stator blades 38 extending radially inwardly from the fan barrel portion 34, and a motor ring 42 supported by the radially inner ends of the stator blades 38. The motor ring 42 supports the motor 18 on the shroud 14. As best shown in FIGS. 2 and 3, the motor ring 42 includes a plurality of mounting portions 46 to which the motor 18 is mounted.

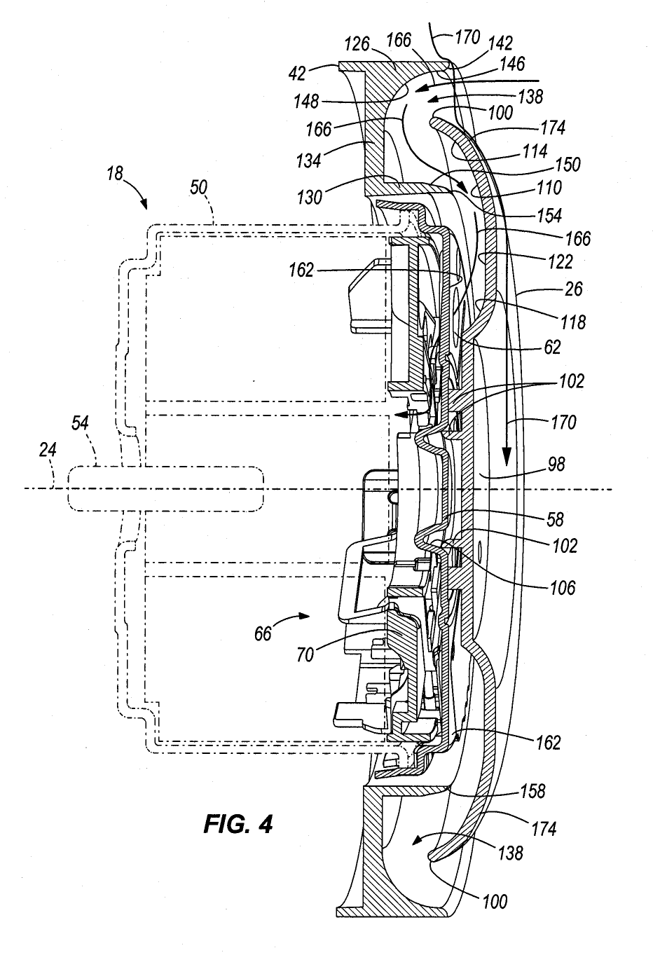

The motor 18 includes a housing 50, an output shaft 54 (see FIG. 2) extending from one end of the housing 50 and defining the central axis 24, and a motor end shield 58 coupled to the other end of the housing 50. The motor end shield 58 includes one or more apertures 62 (see FIGS. 3 and 4) positioned about the motor end shield 58 to allow a cooling airflow to enter the housing 50 and cool the internal components of the motor 18, including a brush assembly 66 having brushes (not shown) and a brush card 70 (see FIGS. 3 and 4).

The fan 22 is an axial-flow fan that is coupled to the output shaft 54 for rotation therewith about the central axis 24. The fan 22 includes a central hub 74 that is coupled to the output shaft 54, a plurality of blades 78 extending radially outwardly from the hub 74, and a band 82 encircling the tips of the blades 78. It is to be understood that the illustrated fan 22 is just one fan design that can be used in the fan assembly 10. Other fan designs, having different numbers of blades and different blade configurations can also be used. Additionally, in some embodiments the band 82 can be eliminated.

As seen in FIG. 3, the hub 74 of the fan 22 includes a plurality of ribs 84 in facing relation to the end of the motor 18 from which the output shaft 54 extends. Rotation of the fan 22 causes the rotation of the ribs 84, which helps draw cooling air through the apertures 62 in the motor end shield 58, into the housing 50, over the brush assembly 66, and through exit apertures 86 (see FIG. 2) in the end of the housing 50 adjacent the hub 74.

The splash shield 26 is positioned adjacent the motor end shield 58. The splash shield 26 and the motor ring 42 together define a system for reducing the amount of debris and liquid that can enter the motor 18 with the cooling airflow, while at the same time improving the flow of air into the motor 18.

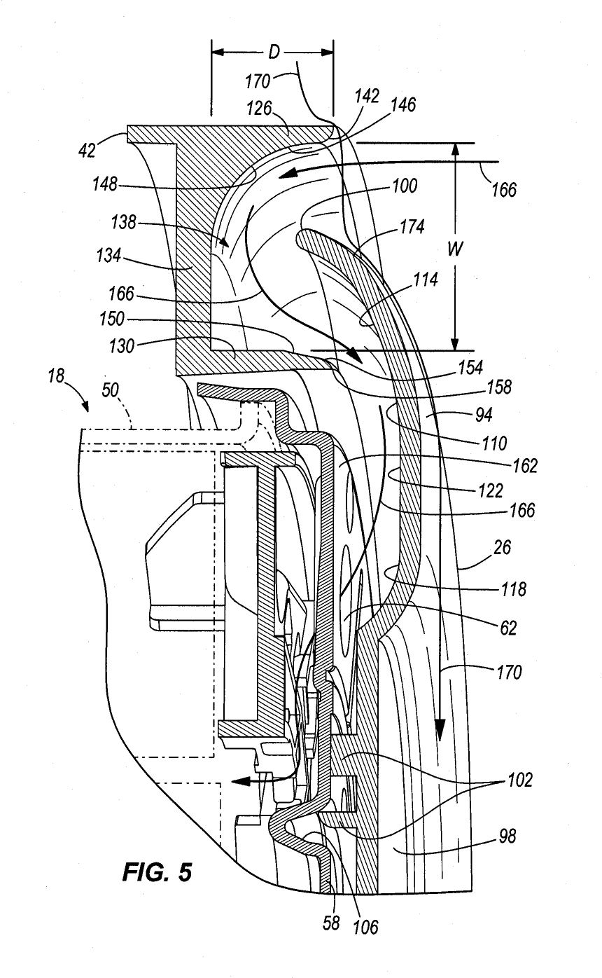

Referring now to FIGS. 4 and 5, the splash shield 26 includes a rim 94 defining the radially outer portion of the splash shield 26, and a hub 98 positioned radially inside the rim 94. The hub 98 is generally planar, while the rim 94 is generally arcuate and extends to a peripheral edge 100. While the illustrated splash shield 26 is an integrally formed plastic part, in which the rim 94 and the hub 98 are formed as a single piece, in other embodiments, other materials can be used and multi-part constructions can be employed. The hub 98 includes an optional centering feature 102 to assist in aligning and centering the splash shield 26 relative to the motor end shield 58. In the illustrated embodiment, the centering feature 102 takes the form of one or more annular projections sized and configured to be at least partly received in a corresponding annular groove 106 in the motor end shield 58. Furthermore, but while not shown, the hub 98 can include an attachment feature for securing the splash shield 26 to the motor end shield 58. In some embodiments, the centering feature 102 can also act as the attachment feature. In other embodiments, other fasteners and fastening arrangements can be used to secure the splash shield 26 to the motor end shield 58 at the hub 98. In yet other embodiments, the splash shield 26 can be secured to the motor ring 42 using various snap fit arrangements on the rim 94. For example, resilient projections formed on the splash shield 26 and spaced circumferentially about the rim 94 can engage the mounting portions 46 of the motor ring 42 to secure the splash shield 26 relative to the motor ring 42 and the motor end shield 58.

Still referring to FIGS. 4 and 5, the rim 94 has an inner surface 110 in facing relationship with the motor end shield 58 and the motor ring 42. The inner surface 110 is generally concave in shape, and in the illustrated embodiment includes a peripheral, first arcuate portion 114, a second arcuate portion 118 radially inward of the first arcuate portion 114, and a generally planar portion 122 intermediate the first and second arcuate portions 114, 118. Together, the first arcuate portion 114, the second arcuate portion 118, and the generally planar portion 122 define the generally concave inner surface 110 of the rim 94. In other embodiments, the contour of the inner surface 110 can be varied from that shown, while still remaining generally concave. For example, the first and second arcuate portions 114 and 118 could be generally planar, but angled relative to the generally planar portion 122 to still define a generally concave contour. In other embodiments, the generally planar portion 122 could be eliminated such that the first and second arcuate portions 114, 118 transition directly into each other. Furthermore, the illustrated curvatures of the arcuate portions 114, 118 could be varied from those shown, and the illustrated length of the generally planar portion 122 could be varied as desired to achieve the optimum airflow, as will be discussed in more detail below.

The motor ring 42 is configured to cooperate with the splash shield 26 to control the airflow into the motor 18. The motor ring 42 includes a radially outer wall 126, a radially inner wall 130, and a base wall 134 extending between the inner and outer walls 126, 130. Together, the outer wall 126, the inner wall 130, and the base wall 134 define a substantially annular channel 138 about the periphery of the motor ring 42. As shown in FIG. 3, the mounting portions 46 are formed in the substantially annular channel 138, such that the channel 138 is interrupted by the mounting portions 46, yet is still substantially annular. In other embodiments, the mounting portions 46 may not interrupt the channel 138.

The illustrated outer wall 126 has an arcuate edge 142 that transitions to a radially inner surface 146 of the outer wall 126. In the illustrated embodiment, the arcuate edge 142 is formed with a radius ranging between about 1 mm to about 3 mm, and is a function of the wall thickness of the outer wall 126. The radially inner surface 146 transitions in an arcuate manner into the base wall 134 such that the outer wall 126 and the base wall 134 define an arcuate transition 148 therebetween. In the illustrated embodiment, the arcuate transition 148 between the inner surface 146 of the outer wall 126 and the base wall 134 is formed with a radius ranging between about 5 mm to about 15 mm.

The inner wall 130 and the base wall 134 intersect in the annular channel 138 at an angle of about ninety degrees. Further from the base wall 134, a radially outer surface 150 of the inner wall 130 is inclined relative to the central axis 24 to define a beveled end 154 of the inner wall 130. A distal end 158 of the inner wall 130 is substantially co-planar with a distal end surface 162 of the motor end shield 58. Additionally, the inner wall 130 and the outer wall 126 extend from the base wall 134 substantially the same distance toward the splash shield 26 in the axial direction such that the arcuate edge 142 and the distal end 158 are substantially or nearly co-planar.

The annular channel 138 has a depth D (see FIG. 5) as measured from the arcuate edge 142 of the outer wall 126 to the surface of the base wall 134 defining the lower-most point in the annular channel 138. The peripheral edge 100 of the rim 94 extends into the annular channel 138 a distance of about 0.1 D to about 0.4 D from a plane containing the arcuate edge 142 and perpendicular to the central axis 24, and can extend into the annular channel 138 a distance of about 0.2 D to about 0.3 D. In the illustrated embodiment, the peripheral edge 100 of the rim 94 overlaps both the outer wall 126 and the inner wall 130 by about 2 mm in the axial direction.

The annular channel also has a width W (see FIG. 5) as measured from the radial inner surface 146 of the outer wall 126 to the radial outer surface 150 of the inner wall 130. The peripheral edge 100 of the rim 94 extends radially over the annular channel 138 a distance of about 0.4 W to about 0.7 W from the radial outer surface 150 of the inner wall 130, and can extend radially over the annular channel 138 a distance of about 0.5 W to about 0.6 W from the radial outer surface 150 of the inner wall 130.

The above-mentioned features and relationships of the splash shield 26 and the motor ring 42 facilitate the flow of cooling air to the motor 18 while still functioning to substantially prevent debris and liquid from entering the motor 18 with the cooling air. The arrows 166 represent the flow of cooling air into the motor 18. The arcuate edge 142 of the outer wall 126 helps cooling air to flow smoothly into the channel 138. The arcuate transition 148 between the outer wall 126 and the base wall 134 further directs the flow radially inwardly toward the central axis 24. The non-arcuate, ninety-degree intersection between the base wall 134 and the inner wall 130 provides an area where solid particles of debris and any liquid traveling with the cooling airflow will impact the inner wall 130 and get trapped or stopped from continuing further onward with the cooling air.

The air then travels axially along the inner wall 130 and along the splash shield 26, as guided by the peripheral, first arcuate portion 114 of the inner surface and the beveled end 154 of the inner wall 130. The first arcuate portion 114 smoothly directs the airflow in a substantially radial direction toward the central axis 24. The arcuate portion 114 is configured to facilitate laminar flow of the cooling air, and the generally planar portion 122 guides the radially flowing air further inwardly in the radial direction. The generally co-planar nature of the distal end 158 of the inner wall 130 and the distal end surface 162 of the motor end shield 58 helps to minimize or prevent the cooling air from leaking between the inner wall 130 and a radially outer surface of the motor 18.

As the radially flowing air continues toward the central axis 24, it is redirected by the second arcuate surface 118 toward and through the apertures 62 in the motor end shield 58. As shown in FIGS. 4 and 5, the radially innermost location of the apertures 62 corresponds generally with the radially innermost end of the second arcuate portion 118 such that radially traveling cooling air can be re-directed by the second arcuate surface 118 directly into the apertures 62. Furthermore, the centering feature 102 on the hub 98 can prevent cooling air from flowing all the way to the central axis 24, thereby maximizing the flow of cooling air into the apertures 62.

As the cooling air enters the apertures 62, it flows in a direction having both a radial component and an axial component with respect to the central axis 24. In the illustrated embodiment, the airflow may be at an angle of between about thirty degrees and about sixty degrees (e.g., forty-five degrees) relative to the distal end surface 162 of the motor end shield 58. Based on the placement and configuration of the brush card 70 and the brush assembly 66 within the motor 18, this cooling airflow can better flow around the brush card 70 and other brush assembly components, thereby improving the cooling of the motor 18.

As can be understood from the above discussion and the arrows 166, the outer wall 126, the base wall 134, the inner surface 110 of the rim 94, and the inner wall 130 together define a labyrinthine pathway that the cooling air must navigate from outside the motor ring 42 to inside the motor 18. The changes in direction that the cooling air must undergo helps to prevent debris and liquid traveling with the air from ultimately making it all the way into the motor 18. Additionally, the features and relationships discussed above achieve the separation of debris and liquid from the airflow, without sacrificing the sufficient and substantially laminar flow of cooling air into the motor 18. Reduced air loss and reduced turbulence is achieved with the current design, due in part to reduced flow resistance. Furthermore, the entry angle of the airflow through the apertures 62 and into the motor 18 also helps to deliver the airflow around obstructions (e.g., the brush card 70 and other components of the brush assembly 66) within the motor 18 to maximize the cooling capabilities of the air that reaches the motor 18.

The arrow 170 in FIGS. 4 and 5 represents the flow of liquid (e.g., rain water, etc.) that may find its way into the engine compartment of the vehicle. Liquid traveling along the path of the arrow 170 (e.g., vertically due to gravity) is substantially prevented from entering the annular channel 138 in part due to the radial extension of the peripheral edge 100 of the rim 94 over the annular channel 138 a distance of about 0.4 W to about 0.7 W from the radial outer surface 150 of the inner wall 130, and in part due to the peripheral edge 100 of the rim 94 overlapping the outer wall 126 in the axial direction (the extension of the peripheral edge 100 of the rim 94 into the annular channel 138 to a distance of about 0.1 D to about 0.4 D). As the liquid drips over the upper end of the motor ring 42, it will fall and impact the arcuate outer surface 174 of the rim 94 (at the upper end of the rim 94) and continue falling toward the hub 98, over the arcuate surface 174 (at the lower end of the rim 94), and off the splash shield 26. Any liquid that does find its way into the annular channel 138 should be separated from the cooling airflow due to the labyrinthine passageway, as discussed above. Partially closing the gap between the outer wall 126 and the peripheral edge 100 in select areas (e.g., from about the 10 o'clock position to about the 2 o'clock position) could provide additional liquid ingress protection.

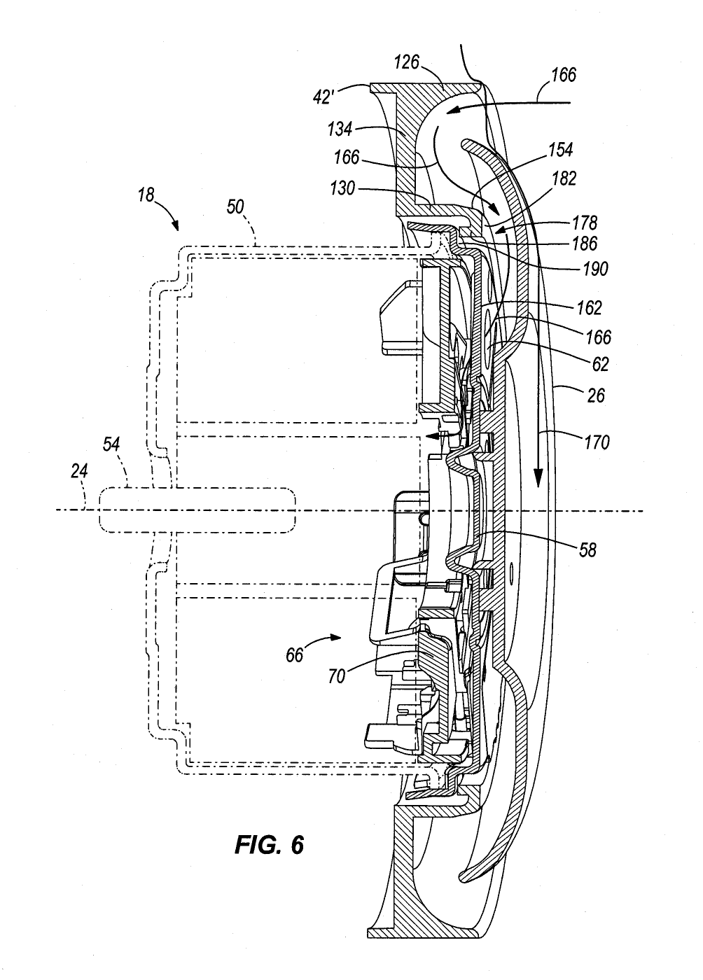

FIG. 6 illustrates a second embodiment including the splash shield 26, the motor end shield 58, the motor 18, and a modified motor ring 42′ that is similar to the motor ring 42. Like parts of the motor ring 42′ have been given like reference numerals. The difference between the motor ring 42′ and the motor ring 42 of the previous embodiment is the configuration of the inner wall 130. Specifically, instead of having the distal end 158 of the motor ring 42, the inner wall 130 includes a formed-over or rolled-over lip 178 sized and configured to further substantially prevent the radial airflow between the splash shield 26 and the motor end shield 58 from leaking between the inner wall 130 and the radially outer surface of the motor 18. In contrast to the first embodiment, which can rely on tightly tolerancing the gap between the inner wall 130 and the outer-most radial surface of the motor end shield 58 to reduce the potential for airflow leakage between the inner wall 130 and the radially outer surface of the motor 18 (i.e., short-circuiting of the cooling airflow), the lip 178 minimizes or eliminates the potential for airflow leaking between the inner wall 130 and the radially outer surface of the motor 18.

The lip 178 extends from the beveled end 154 radially inwardly toward the central axis 24 via a radial lip portion 182, and then extends axially toward the motor end shield 58 via an axial lip portion 186. As with the distal end 158 of the inner wall 130, the radial lip portion 182 defines a surface that is generally co-planar with the distal end surface 162 of the motor end shield 58 and that extends into a radially overlapping arrangement with an axially offset step 190 in the outer periphery of the motor end shield 58. The axial lip portion 186 then extends toward the step 190. This arrangement eliminates any direct axial passageway for cooling airflow to leak between the inner wall 130 and the radially outer surface of the motor 18, while at the same time reducing the need for tightly tolerancing the gap between the inner wall 130 and the outer-most radial surface of the motor end shield 58.

Various features and advantages of the invention are set forth in the following claims.

What is claimed is:

1. A fan assembly comprising:
a motor ring;
an electric motor supported by the motor ring and including
an output shaft defining a central axis,
a brush assembly, and
a motor end shield having at least one aperture and disposed adjacent the brush assembly; and
a splash shield adjacent the motor end shield, the splash shield including a rim having an inner surface in facing relationship with the motor end shield and configured to direct an airflow between the motor end shield and the splash shield in a substantially radial direction toward the central axis, and configured to redirect the substantially radial airflow through the aperture in a direction having both a radial and an axial component with respect to the central axis.

2. The fan assembly of claim 1, wherein the inner surface of the rim is generally concave.

3. The fan assembly of claim 1, wherein the inner surface of the rim includes
a peripheral, first arcuate portion configured to direct an airflow between the motor end shield and the splash shield in the substantially radial direction toward the central axis, and
a second arcuate portion disposed radially inward of the first arcuate portion and in facing relationship with the aperture, the second arcuate portion configured to redirect the substantially radial airflow, through the aperture, in the direction having both the radial component and the axial component with respect to the central axis.

4. The fan assembly of claim 3, wherein the inner surface of the rim further includes a generally planar portion intermediate the first and the second arcuate portions.

5. The fan assembly of claim 1, wherein the splash shield further includes a hub positioned radially inside the rim.

6. The fan assembly of claim 1, wherein the motor ring includes an outer wall, an inner wall, and a base wall extending between the outer and the inner walls, wherein the outer wall, the inner wall, and the base wall together define a substantially annular channel, and wherein the rim of the splash shield extends into the annular channel between the outer and the inner walls such that a labyrinthine pathway is provided by the outer wall, the base wall, the inner surface of the rim, and the inner wall.

7. The fan assembly of claim 6, wherein the outer wall and an edge of the rim overlap by at least about two millimeters in an axial direction.

8. The fan assembly of claim 7, wherein the inner wall and the edge of the rim overlap by at least about two millimeters in the axial direction.

9. The fan assembly of claim 6, wherein the outer wall and the inner wall extend from the base wall substantially the same distance toward the splash shield in an axial direction.

10. The fan assembly of claim 6, wherein the outer wall includes an arcuate edge.

11. The fan assembly of claim 6, wherein the outer wall and the base wall define an arcuate transition therebetween.

12. The fan assembly of claim 6, wherein the inner wall and the base wall intersect at an angle of about ninety degrees.

13. The fan assembly of claim 6, wherein the inner wall includes a beveled end.

14. The fan assembly of claim 6, wherein a distal end of the inner wall is substantially co-planar with an end surface of the motor end shield.

15. The fan assembly of claim 6, wherein the inner wall includes a lip configured to substantially prevent the radial airflow from leaking between the inner wall and a radially outer surface of the motor.

16. The fan assembly of claim 6, wherein the annular channel has a depth D as measured from an edge of the outer wall to the base wall, and wherein an edge of the rim extends into the annular channel a distance of about 0.1 D to about 0.4 D.

17. The fan assembly of claim 16, wherein the edge of the rim extends into the annular channel a distance of about 0.2 D to about 0.3 D.

18. The fan assembly of claim 16, wherein the annular channel has a width W as measured from a radial inner surface of the outer wall to a radial outer surface of the inner wall, and wherein an edge of the rim extends radially over the annular channel a distance of about 0.4 W to about 0.7 W from the radial outer surface of the inner wall.

19. The fan assembly of claim 18, wherein the edge of the rim extends radially over the annular channel a distance of about 0.5 W to about 0.6 W from the radial outer surface of the inner wall.
